(19) United States
(12) Patent Application Publication
(10) Pub. No.: US 2006/0249982 A1
(43) Pub. Date: Nov. 9, 2006

(54) SIDE DOOR ARRANGEMENT OF A MOTOR VEHICLE

(75) Inventor: Norbert FROHNE-BRINKMANN, Merzen (DE)

Correspondence Address: ROBERTS, MLOTKOWSKI & HOBBES, P. O. BOX 10064, MCLEAN, VA, 22102-8064, US

(73) Assignee: Brose Schliesssysteme GmbH & Co. KG, Wuppertal (DE)

(21) Appl. No.: 11/278,833

(22) Filed: Apr. 6, 2006

(30) Foreign Application Priority Data
Apr. 6, 2005 (DE) 20 2005 005 476.3

(51) Int. Cl. B60J 10/08

(52) U.S. Cl. 296/146.9

(57) ABSTRACT

A motor vehicle side door arrangement has front and rear side doors, end sides of the front and rear side doors facing one another when the doors are closed. The rear side door has a lock arrangement and a door handle that is couplable to the lock arrangement for activation thereby. The lock arrangement has a clutch by which a connection between the locking mechanism and the door handle can be activated and deactivated. A mechanical transmission which can be deflected is connected with the clutch, and deflection of the transmission moves the clutch into a position causing deactivation of the door handle of the rear side door. Deflection of the transmission for deactivating of the rear side door door handle is produced by the front side door engaging the transmission when the front side door is closed with the rear side door already closed.

### BACKGROUND OF THE INVENTION

1. Field of the Invention

This invention relates to a side door arrangement of a motor vehicle having a front side door and a rear side door, the front side door being coupled to the motor vehicle body via a front door hinge, the rear side door being coupled to the motor vehicle body via a rear door hinge, the end sides of the two side doors facing one another when closed, the rear side door being assigned a lock arrangement by which the rear side door, in the closed state, can be secured to the motor vehicle body, the rear side door being assigned a door handle which can be coupled to the lock arrangement for activation thereof, and the lock arrangement, for this purpose, having an actuatable clutch, and the securing of the rear side door being released by actuating the activated door handle. The invention also relates to a motor vehicle lock arrangement for the rear side door of such a side door arrangement.

2. Description of Related Art

In all areas of a motor vehicle, enhancing the ease of use is becoming more and more important. This includes, among others, also the requirement for comfortably getting into and out of the vehicle. This requirement relates especially to the configuration of the side door arrangement of a motor vehicle.

Most known motor vehicles are equipped with an A pillar, a B pillar and a C pillar. Here, the B pillar is generally a bottleneck when getting into and out of both the front seats and the back seats. This is the reason that currently the demand for motor vehicles without a B pillar is rising.

A motor vehicle without a B pillar is shown in U.S. Pat. No. 6,779,831. This motor vehicle has a side door arrangement with a front side door and a rear side door, the front side door being coupled to the motor vehicle body via a front door hinge and the rear side door being coupled to the motor vehicle body via a rear door hinge. The end sides of the two side doors face one another when the two side doors are closed. Here, the “end side” means basically the side of the side door opposite the door hinge.

The rear side door is assigned a lock arrangement by which the rear side door in the closed state can be secured to the motor vehicle. Also the front side door is assigned a lock arrangement by which the front side door which is closed can be secured to the rear side door. By the described arrangement of the two side doors relative to one another, the rear side door replaces the B pillar which is otherwise present, to a certain extent. The front side door is “series connected” to the rear side door. In this way, under any circumstances it must be avoided that the securing of the rear side door is released before securing the front side door. This is accomplished in the above described side door arrangement in that the actuation of the rear side door is blocked by the front side door when it is closed.

To actuate the rear side door, there is an inside door handle, by actuation of which the securing of the rear side door can be released. The closed front side door is in the range of motion of this inside door handle such that actuation is possible only when the front side door has already been opened.

In order to implement the aforementioned blocking of the inside door handle of the rear side door, in the above described side door arrangement, it is necessary to arrange the inside door handle in the immediate vicinity of the end side of the rear side door. The disadvantage in this arrangement is the fact that there is considerable danger of pinching for the user. Furthermore, the latitude of configuration in construction and design of the inside door handle is greatly limited.

The likewise known side door arrangement of a motor vehicle known from European Patent Application EP 1 215 064 A1 and corresponding U.S. Pat. No. 6,694,676 (which underlie this invention) avoids the aforementioned disadvantage in that the lock arrangement has an electrically actuatable clutch and that the inside door handle, in this way, can be coupled to the lock arrangement. This is called “activation” of the inside door handle below. To determine whether the front side door is in the opened position or in the closed position, there is an electrical means; such as a sensor or the like. Depending on the sensor signal, the clutch is accordingly electrically actuated.

By using the above described clutch, the inside door handle can be positioned anywhere. This is advantageous with respect to the above described, basically desirable latitude of configuration.

The disadvantage in the known side door arrangement is the fact that the implementation effort is considerable. This is due, first of all, to the fact that additional electrical components, such as an actuator for the clutch and a sensor for determining the position are necessary. Furthermore, the installation effort is increased by the necessary additional cabling. Also, the known side door arrangement is not optimum with respect to operating reliability. Basically, a complex redundant layout is necessary here to meet the maximum requirements.

### SUMMARY OF THE INVENTION

A primary object of this invention is to configure and develop the known side door arrangement of a motor vehicle such that automatic deactivation of the door handle, especially the inside door handle, of the rear door can be implemented with minimum effort and high operating reliability.

This object is achieved in a side door arrangement in which the lock arrangement of the rear side door has a mechanical transmission means which can be deflected, the deflection of the transmission means causing deactivation of the door handle of the rear side door, and when the front side door is closed with the rear side door already closed, the front side door engages the transmission means so as to deflect it, and thus causes deactivation of the door handle of the rear side door.

The consideration that the closing motion of the front side door can be used to automatically deactivate the door handle, especially the inside door handle, of the rear side door is important. For this reason, there is a mechanical transmission means which can be deflected and which is deflected by the closing motion of the front side door, and its deflection, in turn, causes the activation of the door handle, especially of the inside door handle, of the rear side door.

The configuration of the transmission means as a mechanical transmission means makes it possible to eliminate the need for a sensor to automatically deactivate the door handle, especially of the inside door handle, of the rear side door. The closing motion of the front side door is generally associated with the slamming of the front side door, which ensures that enough force or torque is available for deflecting the transmission means.

The preferred configuration in which the transmission means is located on the end side of the rear side door(s) to be accessible from the outside such that when the front side door is closed, with the rear side door already closed, the front side door engages the transmission means and deactivates the door handle of the rear side door, leads to a quite especially simple construction, since the two end sides of the two side doors, in the closed state, are located in the immediate vicinity to one another anyway. This eliminates undesirably long transmission paths.

Another preferred configuration is especially advantageous in that the front side door engages only the pivoting lever for deflecting the transmission means. In a suitable layout this leads to low mechanical losses.

A preferred configuration in which the clutch of the lock arrangement of the rear side door has a first lever which is coupled to the door handle of the rear side door, and a second lever which is otherwise coupled to the lock arrangement, especially to the lock of the lock arrangement, leads to a clutch of the lock arrangement which is especially easy to implement. Complex kinematics can be completely abandoned here.

The motor vehicle lock arrangement for the rear side door of the above described side door arrangement has independent importance the statements made above apply thereto.

Other advantages, features and aspects of this invention will become apparent from the following description of preferred embodiments in accordance with the invention.

### BRIEF DESCRIPTION OF THE DRAWINGS

FIG. 1 is a schematic view of a motor vehicle without a B pillar having a side door arrangement in accordance with the invention,

FIG. 2 is a schematic representation of the side door arrangement of the motor vehicle taken along line II-II in FIG. 1 with the side doors closed,

FIG. 3 is a view as shown in FIG. 2 with the front side door half opened,

FIG. 4 is a view of the encircled detail IV shown in FIG. 3,

FIG. 5 shows the view taken along line V-V in FIG. 3, and

FIG. 6 is a schematic representation of another side door arrangement in accordance with the invention in a view corresponding to that shown in FIG. 4.

### DETAILED DESCRIPTION OF THE INVENTION

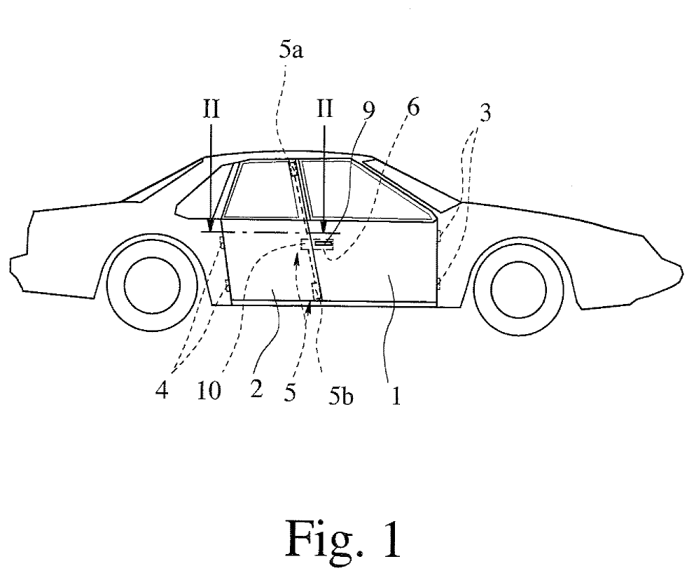

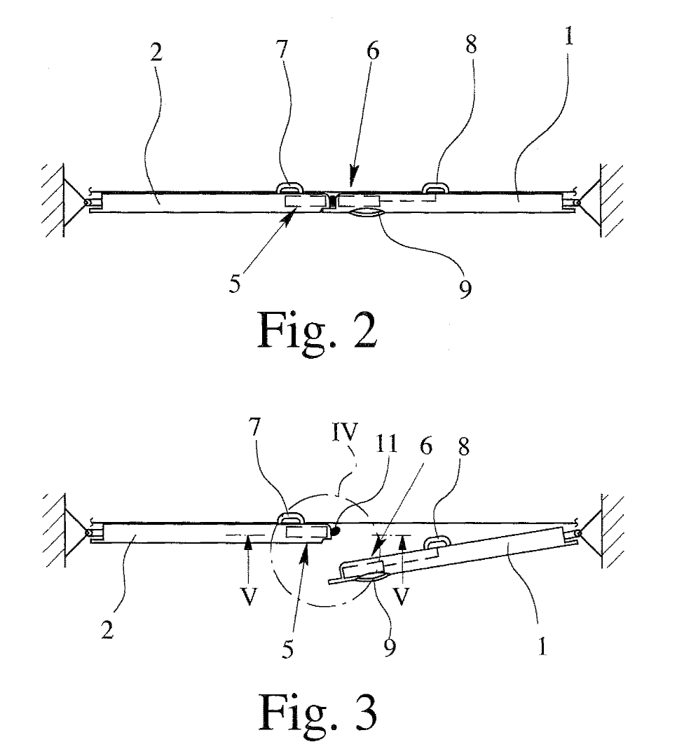

The motor vehicle shown in FIG. 1 is made with five doors. Viewed in the direction of travel, it has one side door arrangement on each side, each of which is equipped with a front side door 1 and with a rear side door 2. The front side door 1 is coupled to the motor vehicle body via a front door hinge 3. The rear side door 2 is coupled accordingly to the motor vehicle body via a rear door hinge 4. The end sides of the two side doors 1, 2 face one another in the closed state, as can be seen from FIG. 2. The “end side,” as noted above, means the side of the side door 1, 2 opposite the respective door hinge 3, 4.

The rear side door 2 is assigned a lock arrangement 5 by which the rear side door 2, in the closed state, can be secured to the motor vehicle. In the embodiment shown in FIG. 1, the lock arrangement 5 has an upper lock 5a and a lower lock 5b. The locks 5a, 5b each preferably have a latch which can be caused to engage a corresponding stationary striker. In this respect the locks are built in the conventional manner. But it can also be provided that the locks 5a, 5b each have an adjustable locking pin which can be caused to engage a corresponding recess on the roof member or on the sill for locking. However, basically, there can also be only one of the two locks 5a, 5b.

The front side door 1 has a lock arrangement 6 by which the front side door 1, when closed, can be secured to the rear side door 2. The lock arrangement 6 of the front side door 1 plays only a subordinate role for this invention, and is not explained detail below.

The B pillar of the motor vehicle can be completely eliminated by the above described securing of the front side door 1 to the rear side door 2 and the rear side door 2 to the motor vehicle body. FIG. 1 together with FIG. 3 shows that the illustrated motor vehicle does not have a B pillar.

The rear side door 2 is assigned a door handle 7 which is made as an inside door handle in this embodiment. Basically, the door handle 7 can, however, also be an outside door handle. Furthermore, it can be provided that the approach in accordance with the invention is applied to the inside door handle, and at the same time, to the outside door handle of the rear side door 2.

For the sake of completeness, it is pointed out that the front side door 1 also has an inside door handle 8 and an outside door handle 9, the two handles 8, 9 being coupled to the lock arrangement 6 of the front side door 1.

For the proposed design, only the lock arrangement 5 and the door handle 7 of the rear side door 2 are of interest. Therefore, basically, reference is made below to the corresponding components of the rear side door 2.

The door handle 7 of the rear side door 2 can be coupled to the lock arrangement 5, and thus, can be activated. For this purpose, the lock arrangement 5 has an actuatable clutch 10. By actuating the activated door handle 7, therefore with the clutch 10 activated, the securing of the rear side door 2 can be released.

The lock arrangement 5 of the rear side door 2 has a mechanical transmission means 11 which can be deflected, deflection of the transmission means 11 causing the deactivation of the door handle 7 of the rear side door 2. The connection between the deflection of the transmission means 11 and the deactivation of the door handle 7 is explained further below.

FIG. 3 shows that, when the front side door 1 is closed, with the rear side door 2 already closed, the front side door 1 engages the transmission means 11, deflects the transmission means 11, and thus, causes deactivation of the door handle 7 of the rear side door 2. This ensures that, with the front side door 1 closed, opening of the rear side door 2 via the door handle 7 of the rear side door 2 is not possible.

It has already been pointed out that the door handle 7 of the rear side door 2 can be an inside door handle or outside door handle. In other words, each actuation element on the rear side door 2 can be automatically deactivated in the above described manner in order to be able to ensure the desired opening sequence.

Examining FIGS. 3 & 4 together shows that the transmission means 11 in the illustrated preferred exemplary embodiment is located on the end side of the rear side door 2 to be accessible from the outside such that when the front side door 1 is closed, with the rear side door 2 already closed, the front side door 1 engages the transmission means 11 and deactivates the door handle 7 of the rear side door 2. The advantage of this arrangement of the transmission means 11 was explained above.

There are a series of possibilities for how the front side door 1 can engage the transmission means 11. In the illustrated preferred embodiment, the end side of the front side door 1 engages the transmission means 11. It can also be provided that the front side door 1 is equipped with a separate engagement means which, for example, has a corresponding contour and which is located preferably in the area of the end side of the front side door 1.

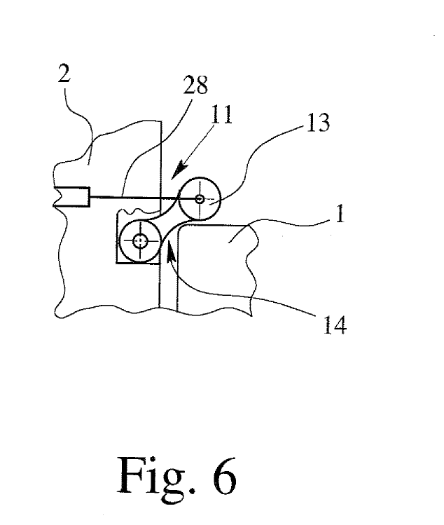

For the transmission means 11, there is also a series of possible implementations. For example, the transmission means 11 can have a Bowden cable 28, by which an economical and generally quiet arrangement results (FIG. 6).

One especially simple construction results from the transmission means 11 having a transmission rod 12 and a transmission lever 13 which is pivotally connected to the transmission rod and is also pivotally mounted on the rear side door 2. Here, the arrangement is preferably such that the transmission rod 12 executes essentially linear movement when the transmission lever 13 pivots. This leads to an especially low requirement for installation space for the respective deflection of the transmission means 11.

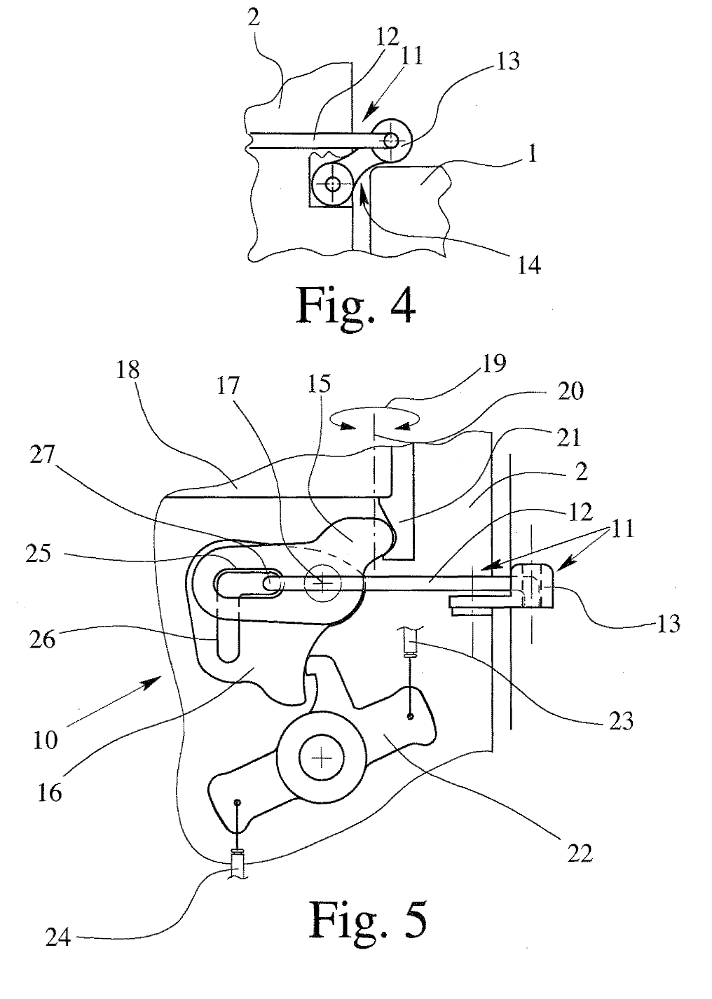

At this point, it is preferably such that, in any case, the transmission lever 13 of the transmission means 11 on the end side of the rear side door 2 is arranged to be accessible from the outside such that when the front side door 1 is closed, with the rear side door 2 already closed, the front side door 1 engages the transmission lever 13, and as a result, the transmission means 11 deactivates the door handle 7 of the rear side door 2. For engagement with the front side door 1, the transmission lever 13 preferably has a guide edge 14 as shown in FIG. 4. However, basically, the transmission lever 13 can also be provided with a roller in order to largely avoid friction losses.

The clutch 10 of the lock arrangement of the rear side door 2 has a first lever 15 which is coupled to the door handle 7 of the rear side door 2, and a second lever 16 which is otherwise coupled to the lock arrangement 5. Both levers 15, 16 can be pivoted around the axis 17.

As shown in FIG. 5, the door handle 7 of the rear side door 2 is equipped with a handle 18 and can be pivoted around the axis 20 for actuation in the direction of the arrow 19, this axis 20 being offset a distance into the plane of the drawings. Thus, the actuation of the door handle 8 causes displacement of the actuation element 21 which is coupled to the door handle 8 in FIG. 5 essentially to the left. This, in turn, causes swivelling of the first lever 15 around to the left.

The second lever 16 in the illustrated preferred embodiment is coupled to the upper lock 5a and the lower lock 5b. For this purpose, the second lever 16 can be engaged to a rocker 22 which, in turn, is coupled to the two locks 5a, 5b via two Bowden cables 23, 24. Pivoting of the second lever 16 in FIG. 5 around to the left, and thus, pivoting of the rocker 22 in FIG. 5 around to the right as a result, and causing the securing of the rear side door 2 to be released.

In one especially preferred configuration, the first lever 15 and the second lever 16 each have a link slot 25, 26, and these links slots 25, 26, at least partially overlap each other. The transmission means 11, here the transmission rod 12 is bent into the plane of the drawings on its end 27 facing away from the transmission lever 13 so as run in both of the link slots 25, 26. As a result, deflection of the transmission means 11 can cause activation or deactivation of the door handle 7 of the rear side door 2.

In particular, the first link slot 25 is made essentially as a linear slot while the second link slot 26, conversely, has the shape of a right angle. If in the state shown in FIG. 5, the door handle 7 of the rear side door 2 is activated, the actuation of the door handle 7 causes pivoting of the first lever 15 around to the left, by which torque is transmitted via the first link slot 25, the transmission rod 12 and the second link slot 26 to the second lever 16. The second lever 16 pivots accordingly around to the left in FIG. 5, by which the rocker 22 is caused to pivot around to the right and causing the securing of the rear side door 2 to be release via the two Bowden cables 23, 24.

On the other hand, if the front side door 1 is in the closed state, the transmission means 11 is deflected, the transmission rod 12 being shifted to the left in FIG. 5. In this case, when actuation of the door handle 7 causes pivoting of the first lever 15 in FIG. 5 around to the left, the transmission rod 12 runs in the part of the second link 26 which extends vertically down in FIG. 5, producing no effect on lever 16 and rocker 22, i.e., the door handle 7 is deactivated.

In the above described preferred exemplary embodiment, the door handle 7 of the rear side door 2, in the deactivated state, executes free running when it is activated. However, basically, it can also be provided that the door handle 7 of the rear side door 2 is blocked in the deactivated state. This blocking is undertaken in turn by the clutch 10. The term “clutch” against this background is to be understood in an expanded sense.

In the above described approach to automatic deactivation of the door handle 7 of the rear side door 2, it is especially advantageous that the location of the door handle 7 can be varied in a wide range. In an especially preferred configuration, the door handle 7 of the rear side door 2 is located at a point which is remote from the end side of the rear side door 2. This has advantages especially with respect to effective protection against pinching.

The approach in accordance with the invention is also advantageous with respect to possible faulty operation. For example, the front side door 1 can be easily closed with the door handle 7 of the rear side door 2 pulled without mechanical components jamming against one another. Furthermore, the opening of the front side door 1 with the door handle 7 of the rear side door 2 pulled is for the most part not a problem. Depending on the specific embodiment, here, the corresponding trip-free mechanism need only be provided with spring pretensioning.

Finally, it is pointed out that the approach in accordance with the invention is not limited to a side door arrangement with solely mechanical actuation. For example, in this side door arrangement, electric locks can also be used which are provided with mechanical redundancy. In this case, the door handle 7 of the rear side door 2 is provided with a switch or the like which normally causes motorized release of the securing of the rear side door 2. The corresponding applies to the lock arrangement 5 of the front side door 1.

It is noted that the motor vehicle lock arrangement of the above described side door arrangement has independent importance for use in contexts and the aforementioned statements apply to it as well.

What is claimed is:

1. Side door arrangement of a motor vehicle, comprising:
a motor vehicle body,
a front side door, the front side door being coupled to the motor vehicle body via a front door hinge,
a rear side door, the rear side door being coupled to the motor vehicle body via a rear door hinge, an end side of the rear side door facing an end side of the front side door, and the rear side door having a lock arrangement by which the rear side door, in a closed state, is secured to the motor vehicle body, and the rear side door having a door handle which is coupled to the lock arrangement for releasing the securing of the rear side door in an active state of the door handle,
wherein the lock arrangement of the rear side door has a mechanical transmission which is deflectable in a manner causing deactivation of the door handle of the rear side door,
wherein, when the front side door is closed, with the rear side door already closed, the front side door engages and deflects the mechanical transmission causing deactivation of the door handle of the rear side door.

2. Side door arrangement as claimed in claim 1, wherein the door handle of the rear side door is an inside door handle.

3. Side door arrangement as claimed in claim 1, wherein the mechanical transmission is located on the end side of the rear side door in a position that is accessible from the outside for enabling said deactivation of the door handle of the rear side door when the front side door is closed.

4. Side door arrangement as claimed in claim 1, wherein the mechanical transmission comprises a Bowden cable.

5. Side door arrangement as claimed in claim 1, wherein the mechanical transmission comprises a transmission rod.

6. Side door arrangement as claimed in claim 5, wherein the mechanical transmission comprises a transmission lever which is pivotally mounted on the rear side door and to which the transmission rod is coupled.

7. Side door arrangement as claimed in claim 6, wherein the transmission rod is connected to the transmission lever in a manner causing it to execute an essentially linear movement when the transmission lever pivots.

8. Side door arrangement as claimed in claim 6, wherein the mechanical transmission lever of the transmission means is located on the end side of the rear side door at a position that is accessible from the outside for enabling said deactivation of the door handle of the rear side door when the front side door is closed.

9. Side door arrangement as claimed in claim 8, wherein the transmission lever has a guide edge which is engageable by the front side door.

10. Side door arrangement as claimed in claim 7, wherein the lock arrangement of the rear side door has a clutch that has a first lever which is coupled to the door handle of the rear side door and a second lever which is coupled to the lock arrangement.

11. Side door arrangement as claimed in claim 10, wherein the first lever and the second lever each have a link slot, wherein the link slots partially overlap each other, and wherein the mechanical transmission runs in both link slots such that deflection of the transmission means causes activation of the door handle of the rear side door in one position thereof in said link slots and causes deactivation of the door handle of the rear side door in another position thereof in said link slots.

12. Side door arrangement as claimed in claim 1, wherein the door handle of the rear side door executes a free running movement when it is operated in a deactivated state.

13. Side door arrangement as claimed in claim 1, wherein the door handle of the rear side door is blocked from moving in a deactivated state.

14. Side door arrangement as claimed in claim 1, wherein the door handle of the rear side door is located at a point which is remote from the end side of the rear side door.

15. Motor vehicle lock arrangement for a rear side door of a side door arrangement having a front side door coupled to a motor vehicle body via a front door hinge, the rear side door being coupled to the motor vehicle body via a rear door hinge, and end sides of the front and rear side doors facing one another when closed, the lock arrangement comprising:
a lock mechanism,
an actuatable clutch for establishing a connection, in an installed state of the lock arrangement in a motor vehicle, between a door handle of a rear side door of the motor vehicle and the lock mechanism, whereby the door handle of the rear side door of the motor vehicle is operative for disengaging the lock mechanism.
a mechanical transmission which is deflectable, wherein deflection of the mechanical transmission is operative for moving said clutch into a position deactivating said connection between the door handle of the rear side door when the front side door is closed with the rear side door already closed, mechanical transmission being adapted for engagement by the front side door during closing thereof.

16. Motor vehicle lock arrangement as claimed in claim 15, wherein the mechanical transmission is adapted for being located on the end side of the rear side door in a manner accessible from the outside such that being engaged by the front side door when it is closed.

17. Motor vehicle lock arrangement as claimed in claim 15, wherein the mechanical transmission comprises a Bowden cable.
